(19) United States
(12) Patent Application Publication
(10) Pub. No.: US 2026/0308369 A1
(43) Pub. Date: Oct. 8, 2026

(54) RUBBER COMPOSITION

(71) Applicant: COMPAGNIE GENERALE DES ETABLISSEMENTS MICHELIN, Clermont-Ferrand (FR)

(72) Inventors: THOMAS FERRAND, Clermont-Ferrand (FR); FABIEN ROUDAUT, Clermont-Ferrand (FR)

(21) Appl. No.: 19/482,242

(22) PCT Filed: Apr. 30, 2024
(86) PCT No.: PCT/EP2024/061937

§ 371 Date: Nov. 7, 2025

(30) Foreign Application Priority Data
May 10, 2023 (FR) 2304645

(51) Int. Cl. C08L 23/36; B60C 1/00; B60C 11/00

(52) U.S. Cl. CPC C08L 23/36; B60C 1/0016; B60C 11/0008; B60C 2011/0025; C08L 2207/324; C08L 2312/00

(57) ABSTRACT

A rubber composition comprising at least an elastomer matrix predominantly comprising a highly saturated diene elastomer, which functionalized highly saturated diene elastomer is a copolymer comprising ethylene units and units of a 1,3-diene in which the ethylene units represent at least 50 mol % of the monomer units of the copolymer, preferably at least 60 mol %, a reinforcing filler containing silica, a coupling agent, a crosslinking system, and a liquid butadiene polymer functionalized by at least one alkoxysilyl function, having a number-average molar mass (Mn) of greater than or equal to 1000 g/mol.

### TECHNICAL FIELD

The field of the present invention is that of rubber compositions based on a highly saturated diene elastomer, which are intended to be used in a tyre, notably in its tread.

### PRIOR ART

The use of a highly saturated diene elastomer is known in the manufacture of tyres. For example, the Applicant has described copolymers of ethylene and of 1,3-butadiene and the use thereof in a tyre tread in document WO2014114607A1. This document indicates that the use of these copolymers in treads has the effect of giving the tyre good wear resistance and rolling resistance properties.

Tyre manufacturers are always looking for solutions to improve tyre performance. This research involves the continuous improvement of the properties of the rubber compositions which are used in the manufacture of tyres. The compositions that make up the tyre generally satisfy compromises between performance properties that are difficult to reconcile simultaneously. Thus, it is an ongoing objective for tyre manufacturers to find formulas that make it possible to improve the balance between all of these performance properties.

In the abovementioned field of tyres comprising a highly saturated diene elastomer in the tread, there is a need, particularly under certain conditions of transporting heavy loads, to have rubber compositions which give the tyre good wear resistance without penalizing road handling.

It is known to those skilled in the art that the addition of plasticizers of low molar masses improves the property of tear resistance, a descriptor directly linked to wear resistance. However, the stiffness of the composition is then lowered, and the road handling impacted.

Systems usually used for stiffening a rubber mixture are, on the one hand, vulcanization and, on the other hand, introduction of reinforcing filler. However, these solutions can in turn bring about a reduction in wear resistance.

Continuing its efforts, the Applicant has found a rubber composition which makes it possible to meet this need in the field of application of highly saturated diene elastomers in rubber compositions for tyres, and in particular for the tread. Very particularly, the Applicant has found, against all expectations, a rubber composition which combines the use of a highly saturated diene elastomer with the use of a liquid butadiene polymer functionalized by at least one alkoxysilyl function, and which makes it possible to significantly improve the tear resistance while maintaining, or even increasing, the stiffness of the composition with respect to compositions using a non-functional liquid polybutadiene or else not using a plasticizer of low molar mass. These properties promise to give the tyre good wear resistance properties while providing a good capacity to resist external attacks, particularly when transporting heavy loads.

Thus, a first subject of the invention is such a rubber composition based on at least an elastomer matrix predominantly comprising a functionalized highly saturated diene elastomer, and a liquid butadiene polymer functionalized by at least one alkoxysilyl function.

Another subject of the invention is a pneumatic or non-pneumatic tyre which comprises a rubber composition in accordance with the invention, preferably in its tread.

### SUMMARY OF THE INVENTION

The invention, which is described in greater detail below, has as subject at least one of the embodiments listed in the following points:
1. Rubber composition comprising at least
   an elastomer matrix predominantly comprising a functionalized highly saturated diene elastomer, which functionalized highly saturated diene elastomer is a copolymer comprising ethylene units and units of a 1,3-diene in which the ethylene units represent at least 50 mol % of the monomer units of the copolymer,
   a reinforcing filler containing silica,
   a coupling agent,
   a crosslinking system and
   a liquid butadiene polymer functionalized by at least one alkoxysilyl function, having a number-average molar mass (Mn) of greater than or equal to 1000 g/mol.
2. Rubber composition according to Embodiment 1, in which the ethylene units represent from 50 mol % to 95 mol % of the monomer units of the copolymer.
3. Rubber composition according to either one of the preceding embodiments, in which the ethylene units represent at least 60 mol % of the monomer units of the copolymer of ethylene and of a 1,3-diene, preferably from 60 mol % to 90 mol % of the monomer units of the copolymer.
4. Rubber composition according to any one of the preceding embodiments, in which the functionalized highly saturated diene elastomer contains from 60 mol % to 80 mol % of ethylene units.
5. Rubber composition according to any one of the preceding embodiments, in which the 1,3-diene is 1,3-butadiene, isoprene, myrcene or 3-farnesene, or a mixture of myrcene and of 3-farnesene, preferably 1,3-butadiene.
6. Rubber composition according to any one of the preceding embodiments, in which the functionalized highly saturated diene elastomer is a copolymer of ethylene and of 1,3-butadiene.
7. Rubber composition according to any one of the preceding embodiments, in which the functionalized highly saturated diene elastomer is a copolymer of ethylene and of 1,3-butadiene and also contains 1,2-cyclohexanediyl units.
8. Rubber composition according to any one of the preceding embodiments, in which the functionalized highly saturated diene elastomer is random.
9. Rubber composition according to any one of the preceding embodiments, in which the functionalized highly saturated diene elastomer has a glass transition temperature of less than −35° C.
10. Rubber composition according to any one of the preceding embodiments, in which the functionalized highly saturated diene elastomer has a glass transition temperature of between −70° C. and −35° C.
11. Rubber composition according to any one of the preceding embodiments, in which the functionalized highly saturated diene elastomer bears at least one silanol or alkoxysilyl function.
12. Rubber composition according to any one of the preceding embodiments, in which the functionalized highly saturated diene elastomer bears at least one silanol or alkoxysilyl function attached directly to the terminal unit of the copolymer by the silicon atom of the function.
13. Rubber composition according to any one of the preceding embodiments, in which the functionalized highly saturated diene elastomer bears at least one silanol or alkoxysilyl function and an amine function.
14. Rubber composition according to any one of the preceding embodiments, in which the functionalized highly saturated diene elastomer bears at least one silanol or alkoxysilyl function and a tertiary amine function.
15. Rubber composition according to any one of the preceding embodiments, in which the functionalized highly saturated diene elastomer bears at least one silanol or alkoxysilyl function attached directly to the terminal unit of the copolymer by the silicon atom of the function, which function corresponds to formula (1)

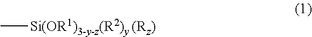

in which
the symbols R¹, which may be identical or different, represent a hydrogen atom or an alkyl group,
the symbols R², which may be identical or different, represent a hydrogen atom or an alkyl group,
the symbol R representing a hydrocarbon chain substituted by an amine function, preferably a tertiary amine,
y being an integer ranging from 0 to 1,
z being an integer ranging from 0 to 1.
16. Rubber composition according to any one of the preceding embodiments, in which the functionalized highly saturated diene elastomer is obtained by functionalization with a functionalizing agent of formula (2)

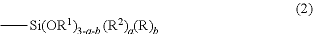

the symbols R¹, which may be identical or different, representing an alkyl group,
the symbols R², which may be identical or different, representing a hydrogen atom or an alkyl group,
the symbol R representing a divalent hydrocarbon group substituted by an amine function, preferably a tertiary amine,
a being an integer ranging from 0 to 1,
b being an integer ranging from 0 to 1.
17. Rubber composition according to the preceding embodiment, in which the symbols R¹ are each a methyl or an ethyl, the symbols R² are methyl or ethyl and R is a 1,3-propanediyl group bearing a tertiary amine function.
18. Rubber composition according to any one of the preceding embodiments, in which the content of functionalized highly saturated diene elastomer varies within a range extending from 60 to 100 phr, preferably from 80 to 100 phr and very preferentially from 90 to 100 phr.
19. Composition according to any one of the preceding embodiments, in which the liquid butadiene polymer is a liquid polybutadiene functionalized by at least one alkoxysilyl function, which alkoxysilyl function is a trialkoxysilyl function, optionally completely or partially hydrolysed, corresponding to the formula —Si(OR)₃, in which R denotes a C₁-C₁₀ alkyl, preferably C₁-C₄ alkyl.
20. Composition according to any one of the preceding embodiments, in which the alkoxysilyl function is a trimethoxysilyl or triethoxysilyl function, which is optionally completely or partially hydrolysed.
21. Composition according to any one of the preceding embodiments, in which the functionalized liquid butadiene polymer bears at least one pendant alkoxysilyl function along the chain.
22. Composition according to any one of the preceding embodiments, in which the functionalized liquid butadiene polymer bears an alkoxysilyl function at at least one of the two ends of the main chain.
23. Composition according to any one of the preceding embodiments, in which the liquid butadiene polymer bears an alkoxysilyl function at each of two ends of the main chain.
24. Composition according to any one of the preceding embodiments, in which the content of functionalized liquid butadiene polymer is within a range extending from 0.5 to 25 phr, preferably from 1 to 20 phr, more preferentially from 5 to 15 phr.
25. Composition according to any one of the preceding embodiments, in which the liquid butadiene polymer has a Tg within a range extending from −100° C. to −60° C., more preferentially from −90° C. to −70° C.
26. Composition according to any one of the preceding embodiments, in which the liquid butadiene polymer has a number-average molar mass within a range extending from 1000 g/mol to 50 000 g/mol, preferably within a range extending from 1000 g/mol to 30 000 g/mol, even more preferably within a range extending from 1000 g/mol to 10 000 g/mol, measured by SEC.
27. Composition according to any one of the preceding embodiments, in which the liquid butadiene polymer has a number-average molar mass within a range extending from 2000 g/mol to 5000 g/mol, more preferably within a range extending from 2000 g/mol to 4000 g/mol.
28. Composition according to any one of the preceding embodiments, in which the reinforcing filler comprises a silica as the predominant reinforcing filler.
29. Composition according to any one of the preceding embodiments, in which the content of reinforcing filler is within a range extending from 10 to 70 phr.
30. Composition according to any one of the preceding embodiments, in which the content of silica is within a range extending from 10 to 70 phr.
31. Finished or semi-finished product comprising a rubber composition as defined in any one of the preceding embodiments.
32. Tyre comprising a rubber composition as defined in any one of Embodiments 1 to 30.
33. Tyre, the tread of which comprises a rubber composition as defined in any one of Embodiments 1 to 30.

### Definitions

For the purposes of the present invention, the expression “part by weight per hundred parts by weight of elastomer” (or phr) should be understood as meaning the part by mass per hundred parts by mass of elastomer.

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present text, when an interval of values is denoted by the expression “from a to b”, the interval represented by the expression “between a and b” is also denoted.

In the present application, the expression “all of the monomer units of the elastomer” or “the total amount of the monomer units of the elastomer” means all the constituent repeating units of the elastomer which result from the insertion of the monomers into the elastomer chain by polymerization. Unless otherwise indicated, the contents of a monomer unit or repeating unit in the highly saturated diene elastomer are given as molar percentages calculated on the basis of all of the constituent monomer units of the elastomer.

When reference is made to a “predominant” compound, this means, for the purposes of the present invention, that this compound is predominant among the compounds of the same type in the composition, that is to say that it is the one which represents the greatest amount by mass among the compounds of the same type. Thus, for example, a predominant elastomer is the elastomer representing the greatest mass relative to the total mass of the elastomers in the composition.

Similarly, a “predominant” filler is the one representing the greatest mass among the fillers of the composition. By way of example, in a system comprising only one elastomer, the latter is predominant for the purposes of the present invention; and in a system comprising two elastomers, the predominant elastomer represents more than half of the mass of the elastomers. In contrast, a “minor” compound is a compound which does not represent the greatest fraction by mass among the compounds of the same type. Preferably, the term “predominant” means a proportion by mass of more than 50%; when the compound represents 100% by mass, it is also referred to as “predominant”.

The term “alkoxy” denotes a radical —OR in which R represents an alkyl radical.

The term “alkyl” denotes a saturated, linear or branched hydrocarbon radical comprising from 1 to 20 carbon atoms, preferably from 1 to 10 carbon atoms, for example the methyl and ethyl radical and the propyl, butyl, pentyl, hexyl, heptyl, octyl, nonyl and decyl radicals.

The expression “divalent hydrocarbon group” denotes a linear or branched, saturated or unsaturated divalent group comprising from 1 to 20 carbon atoms, preferably from 1 to 10 carbon atoms, more preferably from 1 to 6 carbon atoms, the methanediyl and ethanediyl group, the propanediyl, butanediyl, pentanediyl and hexanediyl radicals.

The compounds mentioned in the description may be of fossil origin or may be biobased. In the latter case, they may be partially or completely derived from biomass or obtained from renewable raw materials derived from biomass. Similarly, the compounds mentioned may also originate from the recycling of already-used materials, i.e. they may be partially or completely derived from a recycling process, or else be obtained from raw materials which themselves are derived from a recycling process. Polymers, plasticizers, fillers, and the like, are notably concerned.

### DETAILED DESCRIPTION OF THE INVENTION

### 1 Elastomer Matrix

The term “elastomer matrix” means all the elastomers of the composition.

According to the invention, the elastomer matrix predominantly comprises at least one functionalized highly saturated diene elastomer, namely a functionalized copolymer containing ethylene units and 1,3-diene units (referred to hereinbelow as “the copolymer”).

The functionalized highly saturated diene elastomer that is useful for the purposes of the invention is a copolymer, preferably random copolymer, bearing at least one function. In a known manner, the term “random copolymer” means a copolymer in which the sequential distribution of the monomer units obeys a known statistical law.

The functionalized highly saturated diene elastomer useful for the purposes of the invention is a copolymer which comprises ethylene units resulting from the polymerization of ethylene. In a known manner, the expression “ethylene unit” refers to the —(CH₂—CH₂)— unit resulting from the insertion of ethylene into the elastomer chain.

The highly saturated diene elastomer is rich in ethylene units, since the ethylene units represent at least 50 mol % of all of the monomer units of the elastomer. The maximum proportion of the ethylene units is set by the elastomeric nature of the polymer; this proportion is preferably at most 95 mol %, more preferentially at most 90 mol %. Thus, preferably, the highly saturated diene elastomer comprises from 50 mol % to 95 mol % of ethylene units with respect to all of the monomer units of the copolymer.

According to embodiments of the invention, the copolymer comprises at least 60 mol % of ethylene units. In other words, according to these embodiments, the ethylene units represent at least 60 mol % of all of the monomer units of the copolymer.

According to these embodiments of the invention, the highly saturated diene elastomer preferably comprises from 60 mol % to 90 mol % of ethylene units, more preferably 60 mol % to 80 mol %, the molar percentage being calculated on the basis of all of the monomer units of the copolymer.

The functionalized highly saturated diene elastomer according to the invention also comprises 1,3-diene units resulting from the polymerization of at least one 1,3-diene. In a known manner, the expression “1,3-diene unit” refers to the units resulting from the insertion of the 1,3-diene.

The 1,3-diene units are those for example of a 1,3-diene having 4 to 24 carbon atoms, preferably of a 1,3-diene having 4 to 15 carbon atoms, more preferably of a 1,3-diene having 4 to 12 carbon atoms.

The following are suitable in particular as 1,3-diene: butadiene, isoprene, 2,3-di(C₁-C₅ alkyl)-1,3-butadienes, such as for example 2,3-dimethyl-1,3-butadiene, 2,3-diethyl-1,3-butadiene, 2-methyl-3-ethyl-1,3-butadiene or 2-methyl-3-isopropyl-1,3-butadiene, aryl-1,3-butadienes such as phenyl-1,3-butadiene, or 1,3-pentadiene. The following are also suitable as 1,3-diene: a 1,3-diene of formula CH₂═CR—CH═CH₂, in which R represents a hydrocarbon chain containing 3 to 20 carbon atoms, such as for example a linear monoterpene (C₁₀H₁₆), for instance myrcene, a linear sesquiterpene (C₁₅H₂₄), for instance 3-farnesene, etc.

The functionalized highly saturated diene elastomer is preferably a copolymer of ethylene and of a 1,3-diene from among 1,3-butadiene, isoprene, myrcene and 3-farnesene and a mixture of myrcene and of 3-farnesene.

According to embodiments of the invention, the 1,3-diene units are derived from 1,3-butadiene or isoprene, more preferentially from 1,3-butadiene, in which case the highly saturated diene elastomer is a copolymer of ethylene and of 1,3-butadiene, preferably a random copolymer of ethylene and of 1,3-butadiene.

According to the invention, when the highly saturated diene elastomer comprises 1,3-diene units derived from 1,3-butadiene, the highly saturated diene elastomer may also contain 1,2-cyclohexanediyl units. The presence of these cyclic structures in the copolymer results from a very particular insertion of ethylene and 1,3-butadiene during the polymerization. The content of 1,2-cyclohexanediyl units in the copolymer varies according to the respective contents of ethylene and of 1,3-butadiene in the copolymer. The copolymer preferably contains less than 15 mol % of 1,2-cyclohexanediyl units.

The highly saturated diene elastomer that is useful for the purposes of the invention may be obtained according to various synthetic methods known to those skilled in the art, notably as a function of the targeted microstructure of the highly saturated diene elastomer. Generally, it may be prepared by copolymerization at least of a 1,3-diene, preferably 1,3-butadiene, and of ethylene and according to known synthetic methods, in particular in the presence of a catalytic system comprising a metallocene complex. Mention may be made, in this respect, of catalytic systems based on metallocene complexes, which catalytic systems are described in documents EP 1092 731, WO 2004035639, WO 2007054223 and WO 2007054224, as well as WO2020070442, WO2020070443 and WO2020074804 in the name of the Applicant. The highly saturated diene elastomer, including when it is random, can also be prepared by a process using a catalytic system of preformed type, such as those described in documents WO 2017093654 A1, WO 2018020122 A1 and WO 2018020123 A1.

According to embodiments of the invention, the functionalized highly saturated diene elastomer has a glass transition temperature of less than −35° C., more particularly of between −70° C. and −35° C., the glass transition temperature being measured in a known manner by DSC (Differential Scanning Calorimetry) in accordance with standard ASTM D3418 (1999).

According to the invention, the term “functionalized highly saturated diene elastomer that is useful for the purposes of the invention” means a highly saturated diene elastomer bearing at least one function. In the context of the invention, the term “function” means a function capable of interacting with the reinforcing filler comprising silica, i.e. a function capable of forming, within a rubber composition reinforced by means of the filler, a physical or chemical bond with said filler. This interaction can be established, for example, via covalent, hydrogen, ionic and/or electrostatic bonds between said function and functions present on the filler, in particular the silica. This function is preferably an alkoxysilyl or silanol function. The silanol or alkoxysilyl function is then very preferentially attached directly to the terminal unit of the copolymer by the silicon atom of the function.

According to preferred embodiments of the invention, the functionalized highly saturated diene elastomer bears at least one silanol or alkoxysilyl function and an amine function. The silanol or alkoxysilyl function is then very preferentially attached directly to the terminal unit of the copolymer by the silicon atom of the function and bears the amine function. The amine function may be primary, protected or unprotected, secondary, protected or unprotected, or tertiary. The amine function is preferably tertiary.

According to these preferred embodiments, the functionalized highly saturated diene elastomer bears at least one functional group comprising a silanol or alkoxysilyl function and an amine function, which group may be represented by formula (1)

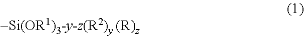

in which the symbols R¹, which may be identical or different, represent a hydrogen atom or an alkyl group,
the symbols R², which may be identical or different, represent a hydrogen atom or an alkyl group,
the symbol R representing a hydrocarbon chain substituted by an amine function,
y being an integer ranging from 0 to 1,
z being an integer ranging from 0 to 1.

The functionalized highly saturated diene elastomer according to the invention may be obtained by adding a functionalizing agent at the end of polymerization instead of adding an alcohol that is usually used to stop the polymerization. A functionalized polymer is then recovered.

According to preferred embodiments of the invention, the functionalized highly saturated diene elastomer is obtained by adding, at the end of polymerization, a functionalizing agent of formula (2),

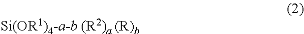

the symbols R¹, which may be identical or different, representing an alkyl group,
the symbols R², which may be identical or different, representing a hydrogen atom or an alkyl group,
the symbol R representing a hydrocarbon chain substituted by an amine function,
a being an integer ranging from 0 to 1,
b being an integer ranging from 0 to 1.

In formulae (1) and (2),
the alkyl group represented by the symbol R¹ is a C₁-C₁₀ alkyl group, preferably a C₁-C₄ alkyl group, more preferably methyl or ethyl;
the alkyl group represented by the symbol R² is a C₁-C₁₀ alkyl group, preferably C₁-C₄ alkyl group, more preferably methyl or ethyl;
the hydrocarbon chain substituted by an amine function represented in the symbol R is preferably a C₁-C₁₀ alkanediyl chain, preferably comprising at most 6 carbon atoms, more preferentially the 1,3-propanediyl group.

The amine function that is useful for the purposes of the invention and that is in particular designated in the symbol R in formulae (1) and (2) is a protected primary amine function, a protected secondary amine function or a tertiary amine function. Protecting groups for the primary amine and secondary amine functions that may be mentioned include silyl groups, for example trimethylsilyl and tert-butyldimethylsilyl groups. Preferably, the amine function is a tertiary amine function. Advantageously, the amine function is a tertiary amine function of formula —N(R′)₂ in which each R¹ represents an alkyl, preferentially a methyl or an ethyl.

Mention may be made, as functionalizing agent for preparing a polymer bearing an amine function according to the first variant, of the compounds (N,N-dimethyl-3-aminopropyl)methyldimethoxysilane, (N,N-dimethyl-3-aminopropyl)methyldiethoxysilane, (N,N-dimethyl-3-aminopropyl)ethyldimethoxysilane, (N,N-dimethyl-3-aminopropyl)ethyldiethoxysilane, (N,N-dimethylaminopropyl)trimethoxysilane, (N,N-dimethylaminopropyl)triethoxysilane, (N-(3-trimethoxysilyl)propyl)-N-(trimethylsilyl)silanamine and (N-(3-triethoxysilyl)propyl)-N-(trimethylsilyl)silanamine, preferably (N,N-dimethyl-3-aminopropyl)methyldimethoxysilane, (N,N-dimethyl-3-aminopropyl)ethyldimethoxysilane, (N,N-dimethylaminopropyl)trimethoxysilane and (N-(3-trimethoxysilyl)propyl)-N-(trimethylsilyl)silanamine, more preferentially (N,N-dimethylaminopropyl)trimethoxysilane and (N-(3-trimethoxysilyl)propyl)-N-(trimethylsilyl)silanamine.

The functionalizing agent is typically added to the polymerization medium. It is typically added to the polymerization medium at a degree of conversion of the monomers selected by those skilled in the art depending on the desired macrostructure of the copolymer. Since the polymerization step is generally carried out under ethylene pressure, a degassing of the polymerization reactor may be carried out before the addition of the functionalizing agent. The functionalizing agent is added under inert and anhydrous conditions to the polymerization medium, maintained at the polymerization temperature. Use is typically made of from 0.25 to 10 mol of functionalizing agent per 1 mol of cocatalyst, preferably of from 2 to 4 mol of functionalizing agent per 1 mol of cocatalyst. The functionalizing agent is brought into contact with the polymerization medium for a time sufficient to enable the functionalization reaction. This contact time is judiciously selected by those skilled in the art as a function of the concentration of the reaction medium and of the temperature of the reaction medium. Typically, the functionalization reaction is carried out under stirring, at a temperature ranging from 17° C. to 80° C., for 0.01 to 24 hours.

When the functionalizing agent bears a protected function as described above, the step of functionalization of the polymer can be followed by a hydrolysis reaction to form a copolymer bearing a deprotected function, such as a primary amine or a secondary amine.

A hydrolysis reaction may also follow the functionalization reaction of the polymer. The hydrolysis of the polymer bearing an alkoxysilyl function leads to the preparation of a polymer bearing a silanol function.

The highly saturated diene elastomer that is useful for the purposes of the invention may consist of a mixture of highly saturated diene elastomers which differ from each other in their microstructures or in their macrostructures.

According to the invention, the content of the highly saturated diene elastomer in the rubber composition is preferably at least 50 parts by weight per hundred parts of elastomer of the rubber composition (phr). More preferably, the content of highly saturated diene elastomer in the rubber composition varies in a range extending from 60 to 100 phr, preferentially 80 to 100 phr. More preferentially, it varies within a range extending from 90 to 100 phr.

In addition, the elastomer matrix of the composition of the invention may comprise at least one other elastomer, in a minor amount. Of note in particular are the diene elastomers known to those skilled in the art for their use in the field of tyres, such as a polybutadiene (abbreviated to “BR”), a synthetic polyisoprene (IR), natural rubber (NR), a butadiene copolymer such as a butadiene-styrene copolymer (SBR), an isoprene copolymer and mixtures of these elastomers.

### 2 Functionalized Liquid Butadiene Polymer

The term “butadiene polymer” means a butadiene homopolymer or copolymer, in other words a diene polymer selected from the group consisting of polybutadienes, the various butadiene copolymers, and mixtures of these polymers. Among the butadiene copolymers, mention will be made in particular of copolymers of butadiene and of a vinylaromatic monomer, preferably styrene. Among the copolymers suitable are those containing at least 80% by weight of units derived from butadiene. Preferably, the liquid butadiene polymer is a liquid polybutadiene.

According to the invention, the liquid butadiene polymer is liquid at ambient temperature (around 23° C. at 1 atm); that is to say, as a reminder, substances having the capacity to ultimately take the form of their container. The Tg thereof is preferentially less than −20° C., more preferentially less than −40° C. According to one embodiment of the invention, the liquid butadiene polymer has a Tg of less than −60° C., for example within a range extending from −100° C. to −60° C., preferably within a range extending from −95° C. to −65° C., more preferably within a range extending from −90° C. to −70° C.

According to the invention, the liquid butadiene polymer functionalized along the chain has a number-average molar mass (Mn) of greater than or equal to 1000 g/mol and preferentially less than or equal to 50 000 g/mol, more preferentially less than or equal to 30 000 g/mol, more preferentially still less than or equal to 10 000 g/mol. Thus, according to certain embodiments, the liquid butadiene polymer functionalized along the chain has a number-average molar mass (Mn) within a range extending from 1000 g/mol to 10 000 g/mol.

According to other embodiments of the invention, the liquid butadiene polymer has a number-average molar mass (Mn) of greater than or equal to 1000 g/mol and preferentially less than or equal to 6000 g/mol, more preferably less than or equal to 5500 g/mol, more preferably within a range extending from 1000 g/mol to 5000 g/mol, more preferably within a range extending from 2000 g/mol to 4000 g/mol.

The Tg of the liquid polymer is measured according to the standard ASTM D3418 (1999). The macrostructure (Mw, Mn and PDI) of the liquid polymer is determined by size exclusion chromatography (SEC): solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 Waters columns in series (Styragel HR4E, HR1 and HR0.5); detection by differential refractometer (Waters 2410) and its associated operating software (Waters Empower).

According to the invention, the liquid butadiene polymer is functionalized by at least one alkoxysilyl function. The term “functionalized polymer” means a polymer comprising at least one alkoxysilyl functional group attached to the main chain of the polymer, this at least one group possibly being pendant along the main chain of the polymer or situated at one of its two ends. The expression “by at least one alkoxysilyl function” means one or more alkoxysilyl functions.

The polymer thus comprises an average number of at least 1 function per chain, preferably of at least 1.3, more preferably of at least 2.0. The average functionality can be calculated via the number-average molar mass (Mn) of the liquid butadiene polymer and the number of alkoxysilyl functions.

The term “alkoxysilyl function” means a function corresponding to the formula —Si(OR)ₙR₃₋ₙ; each R, independently of one another, represents a C₁-C₁₀ alkyl radical, preferably C₁-C₄ alkyl radical, and n is an integer from 1 to 3. Preferably, the alkoxysilyl function is a trialkoxysilyl function corresponding to the formula —Si(OR)₃. More preferentially still, the alkoxysilyl function is a trimethoxysilyl or triethoxysilyl function. Depending on the medium in which the functionalized liquid butadiene polymer is used, those skilled in the art will understand that the alkoxysilyl functions may be partially or completely hydrolysed.

All the preferential and advantageous aspects concerning the functionalized liquid butadiene polymer can be combined according to the invention.

According to embodiments of the invention, the functionalized liquid butadiene polymer is functionalized at each chain end by an alkoxysilyl function. Preferably according to this embodiment, the functionalized liquid butadiene polymer is a functionalized liquid polybutadiene bearing a trialkoxysilyl function, preferably trimethoxysilyl or triethoxysilyl function, at each chain end. Such polymers can be obtained in a simple and known manner by functionalization of a liquid telechelic butadiene polymer bearing —OH functions at the chain ends, obtained by radical polymerization, with a functionalizing agent of alkoxysilane type capable of reacting with the —OH functions of the polymer. Mention may be made of alkoxysilane compounds bearing an isocyanate function as functionalizing agent. Such polymers and the synthesis thereof are for example described in document WO2016180649A1. According to these embodiments, the at least one alkoxysilyl function may be bonded to the butadiene polymer directly by a covalent bond or via a hydrocarbon group which may comprise one or more heteroatoms chosen from N and 0.

According to embodiments of the invention, the functionalized liquid butadiene polymer is functionalized along the chain and bears one or more pendant alkoxysilyl functions. Preferably according to this embodiment, the functionalized liquid butadiene polymer is a functionalized liquid polybutadiene bearing one or more trialkoxysilyl functions, preferably trimethoxysilyl or triethoxysilyl functions, along the chain. The pendant alkoxysilyl functions along the chain may be obtained in a simple and known manner by hydrosilylation of the pendent carbon-carbon double bonds of the 1,2-vinyl units of the butadiene part of a liquid butadiene polymer. Such polymers are for example described in documents EP3466996A1 and EP3293217A1.

Liquid butadiene polymers which are useful for the purposes of the invention may be found commercially for example under the names POLYVEST EP ST-E 60 and POLYVEST EP ST-E 100 sold by Evonik, and X-12-1267B, X-12-1267B-ES and X-12-1287A sold by Shin-Etsu.

According to any one of the embodiments of the invention, the content of functionalized liquid butadiene polymer is advantageously greater than or equal to 0.5 phr, preferably within a range extending from 0.5 phr to 25 phr, preferentially from 1 to 20 phr, more preferentially from 5 phr to 15 phr.

The liquid butadiene polymer functionalized by at least one alkoxysilyl function may be a mixture of several liquid butadiene polymers functionalized by at least one alkoxysilyl function as described above.

### 3 Reinforcing Filler

The composition according to the invention comprises a reinforcing filler comprising silica.

Other than silica, use may also be made of at least one other reinforcing filler known for its ability to reinforce a rubber composition which can be used for the manufacture of tyres, for example an organic filler, such as carbon black, a reinforcing inorganic filler other than silica, such as alumina, or else a blend of these two types of filler. More particularly, if the reinforcing filler comprises a filler other than silica, it comprises a carbon black.

All carbon blacks, notably “tyre-grade” blacks, are suitable as carbon blacks. Among the latter, mention will be made more particularly of the reinforcing carbon blacks of the 100, 200 or 300 series (ASTM grades), such as the N115, N134, N234, N326, N330, N339, N347 or N375 blacks, or else, depending on the applications targeted, blacks of higher series (for example N660, N683 or N772). The carbon blacks might, for example, be already incorporated in an isoprene elastomer in the form of a masterbatch (see, for example, applications WO 97/36724 and WO 99/16600).

Mention may be made, as examples of organic fillers other than carbon blacks, of functionalized polyvinyl organic fillers, such as described in applications WO-A-2006/069792, WO-A-2006/069793, WO-A-2008/003434 and WO-A-2008/003435.

The composition may contain one type of silica or a blend of several silicas. The silica used may be any reinforcing silica known to those skilled in the art, in particular any precipitated or fumed silica having a BET specific surface area and a CTAB specific surface area which are both less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Solvay, the Hi-Sil EZ150G silica from PPG, the Zeopol 8715, 8745 and 8755 silicas from Huber, treated precipitated silicas, such as, for example, the silicas “doped” with aluminium described in application EP-A-0735088, or the silicas with a high specific surface area as described in application WO 03/16837.

According to an embodiment of the invention, the reinforcing filler is predominantly silica; that is to say that it preferably comprises more than 50% by weight of silica relative to the total weight of the reinforcing filler. Optionally according to this variant, the reinforcing filler also comprises carbon black.

In the present disclosure, the BET specific surface area is determined by gas adsorption using the Brunauer-Emmett-Teller method described in “The Journal of the American Chemical Society” (vol. 60, page 309, February 1938), and more specifically according to a method derived from the standard NF ISO 5794-1, appendix E, of June 2010 [multipoint (5 point) volumetric method—gas: nitrogen—degassing under vacuum: one hour at 160° C.—relative pressure p/po range: 0.05 to 0.2]. The CTAB specific surface area values were determined according to the standard NF ISO 5794-1, Appendix G of June 2010. The process is based on the adsorption of CTAB (N-hexadecyl-N,N,N-trimethylammonium bromide) on the “outer” surface of the reinforcing filler.

Those skilled in the art will understand that, as a filler equivalent to silica, use might be made of a reinforcing filler of another nature, in particular organic nature, provided that this reinforcing filler is covered with a layer of silica, or else comprises functional sites, in particular hydroxyl sites, at its surface which require the use of a coupling agent in order to establish the bond between the filler and the elastomer.

The physical state in which the reinforcing filler is provided is not important, whether in the form of a powder, of micropearls, of granules, of beads or any other appropriate densified form.

For the purposes of the invention, the content of total reinforcing filler (silica and optionally carbon black and/or reinforcing inorganic filler other than silica) is preferably from 10 to 100 phr, more preferentially from 15 to 70 phr. Below 10 phr of filler, the composition might not be sufficiently reinforced.

According to one embodiment of the invention, use is made of silica as predominant filler, preferably in a content ranging from 10 to 100 phr, more preferentially from 15 to 70 phr, and optionally of carbon black. The carbon black, when it is present, is then used in a minor amount, preferably at a content within a range extending from 0.1 to 20 phr, more preferentially from 0.5 to 10 phr, in particular from 1 to 5 phr. Within the ranges indicated, the colouring (black pigmentation agent) and anti-UV properties of carbon blacks are exploited, without otherwise penalizing the typical performance provided by the reinforcing inorganic filler.

In order to couple the silica to the diene elastomer, use is made, according to the invention and in a well-known manner, of an at least difunctional coupling agent intended to provide a satisfactory connection, of chemical and/or physical nature, between the inorganic filler (surface of its particles) and the diene elastomer. Use is made in particular of organosilanes or polyorganosiloxanes which are at least difunctional. The term “difunctional” means a compound having a first functional group that is capable of interacting with the inorganic filler and a second functional group that is capable of interacting with the diene elastomer. For example, such a difunctional compound can comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the coupling agents are selected from the group consisting of (symmetrical or asymmetrical) organosilane polysulfides, such as bis(3-triethoxysilylpropyl) tetrasulfide, abbreviated to TESPT, sold under the name Si69 by Evonik, or bis(triethoxysilylpropyl) disulfide, abbreviated to TESPD, sold under the name Si75 by Evonik, polyorganosiloxanes, mercaptosilanes, blocked or partially blocked mercaptosilanes, such as NXT-Silane or NXT-Z45 Silane, sold by Momentive. Of course, use might also be made of mixtures of these coupling agents.

Those skilled in the art will understand that the content of coupling agent depends on the amount of reinforcing inorganic filler to be coupled to the elastomer. Typically, the content of coupling agent represents from 0.5% to 15% by weight, relative to the amount of reinforcing inorganic filler, in particular silica.

The composition according to the invention may optionally also contain coupling activators, agents for covering the inorganic fillers or more generally processing aids capable, in a known manner, by virtue of an improvement in the dispersion of the filler in the rubber matrix and of a lowering of the viscosity of the composition, of improving its ability to be processed in the uncured state, these agents being known moreover.

### 4 Crosslinking System

The crosslinking system may be any type of system known to those skilled in the art in the field of rubber compositions for tyres. It may in particular be based on sulfur and/or on peroxide and/or on bismaleimides.

Preferentially, the crosslinking system is based on sulfur; it is then referred to as a vulcanization system. The sulfur can be provided in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or known vulcanization retardants.

The sulfur is used in a preferential content of between 0.2 phr and 10 phr, more preferentially between 0.3 and 5 phr. The vulcanization accelerator or mixture of vulcanization accelerators is used in a preferential content of between 0.5 and 10 phr, more preferentially between 0.5 and 5 phr.

Use may be made, as accelerator, of any compound that is capable of acting as an accelerator for the vulcanization of diene elastomers in the presence of sulfur, in particular accelerators of the thiazole type, and also derivatives thereof, or accelerators of sulfenamide, thiuram, dithiocarbamate, dithiophosphate, thiourea and xanthate type. As examples of such accelerators, mention may notably be made of the following compounds: 2-mercaptobenzothiazyl disulfide (abbreviated as MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and mixtures of these compounds.

### 5 Possible Additives

The rubber composition according to the invention may optionally also include all or some of the usual additives customarily used in elastomer compositions for tyres: pigments, protective agents such as anti-ozone waxes, chemical anti-ozonants, antioxidants, anti-fatigue agents, plasticizers other than the liquid polybutadiene polymer, reinforcing resins (as described for example in application WO 02/10269).

It goes without saying that the invention relates to the rubber compositions described previously both in the “uncured” or non-crosslinked state (i.e. before curing) and in the “cured” or crosslinked state (i.e. after crosslinking or vulcanization).

### 6 Preparation of the Rubber Composition

The composition in accordance with the invention may be manufactured in appropriate mixers using two successive preparation phases well known to those skilled in the art:
a first phase of thermomechanical working or kneading (known as the “non-productive” phase), that can be performed in a single thermomechanical step during which all the necessary constituents, notably the elastomer matrix, the liquid polybutadiene polymer, the reinforcing filler and the various other optional additives, with the exception of the crosslinking system, are introduced into an appropriate mixer, such as a standard internal mixer (for example of ‘Banbury’ type). The incorporation of the optional filler into the elastomer may be performed in one or more portions while thermomechanically kneading. In the case in which the filler is already incorporated, totally or partly, into the elastomer in the form of a masterbatch, as is described, for example, in applications WO 97/36724 or WO 99/16600, it is the masterbatch which is directly kneaded and, if appropriate, the other elastomers or fillers present in the composition which are not in masterbatch form, and also the various other optional additives other than the crosslinking system, are incorporated. The non-productive phase may be performed at high temperature, up to a maximum temperature of between 110° C. and 200° C., preferably between 130° C. and 185° C., for a period of time generally of between 2 and 10 minutes.
a second phase of mechanical working (known as the “productive” phase), which is carried out in an external mixer, such as an open mill, after cooling the mixture obtained during the non-productive first phase down to a lower temperature, typically less than 120° C., for example between 40° C. and 100° C. The crosslinking system is then incorporated and the combined mixture is then mixed for a few minutes, for example between 5 and 15 min.

Such phases are well known to those skilled in the art.

The final composition thus obtained is then calendered, for example in the form of a sheet or a slab, notably for laboratory characterization, or else is extruded (or co-extruded with another rubber composition) in the form of a rubber semi-finished product (or profiled element) that may be used in a tyre, for example as a tread. These products may then be used for the manufacture of tyres, according to the techniques known to those skilled in the art.

The composition may be either in the uncured state (before crosslinking or vulcanization) or in the cured state (after crosslinking or vulcanization), or may be a semi-finished product which can be used in a tyre.

The crosslinking (or curing), if appropriate the vulcanization, is carried out in a known manner at a temperature generally of between 130° C. and 200° C., for a sufficient time which may vary, for example, between 5 and 90 min depending in particular on the curing temperature, on the crosslinking system adopted and on the kinetics of crosslinking of the composition in question.

### 7 Semi-Finished Product and Tyre

The rubber composition according to the invention has a good tear resistance and a stiffness that are suitable for use for the manufacture of tyres. Thus, a tyre comprising such a composition in its tread promises good wear resistance properties while providing good road handling, especially when transporting heavy loads.

For this reason, another subject of the present invention relates to a semi-finished article in particular for a tyre comprising at least one rubber composition in accordance with the invention and as defined above.

The semi-finished article may be any article which can be used for the manufacture of a finished rubber article such as a tyre. Preferentially, the semi-finished article for a tyre is a tread. The semi-finished articles are obtained via methods that are well known to those skilled in the art.

Another subject of the present invention relates to a tyre comprising at least one rubber composition in accordance with the invention and as described above or comprising at least one semi-finished article for a tyre as described above, in particular the tread. The tyres of the invention are obtained via methods that are well known to those skilled in the art.

The abovementioned features of the present invention, and also others, will be understood more clearly on reading the following description of several exemplary embodiments of the invention, which are given as non-limiting illustrations.

### Exemplary Embodiments of the Invention

### 1 Tests and Measurements:

### 1-1 Determination of the Microstructure of the Elastomers

The microstructure of the elastomers is determined by ¹H NMR analysis, combined with ¹³C NMR analysis when the resolution of the ¹H NMR spectra does not allow all of the species to be assigned and quantified. The measurements are performed using a Bruker 500 MHz NMR spectrometer at frequencies of 500.43 MHz for proton observation and 125.83 MHz for carbon observation.

For the elastomers which are insoluble but which have the ability to swell in a solvent, an HRMAS 4 mm z-grad probe, which makes it possible to observe the protons and the carbons in proton-decoupled mode, is used. The spectra are acquired at spin speeds of 4000 Hz to 5000 Hz.

For the measurements on soluble elastomers, a liquid NMR probe, which makes it possible to observe the protons and the carbons in proton-decoupled mode, is used.

The insoluble samples are prepared in rotors filled with the material analysed and a deuterated solvent which makes swelling possible, in general deuterated chloroform (CDCl₃). The solvent used must always be deuterated and its chemical nature may be adapted by those skilled in the art. The amounts of material used are adjusted so as to obtain spectra with a sufficient sensitivity and resolution.

The soluble samples are dissolved in a deuterated solvent (approximately 25 mg of elastomer in 1 ml), in general deuterated chloroform (CDCl₃). The solvent or solvent blend used must always be deuterated and its chemical nature may be adapted by those skilled in the art.

In both cases (soluble sample or swollen sample):
for proton NMR, a 30° single pulse sequence is used. The spectral window is adjusted to observe all the resonance lines belonging to the molecules analysed. The accumulation number is adjusted in order to obtain a signal to noise ratio which is sufficient for the quantification of each unit. The recycle delay between each pulse is adapted to obtain a quantitative measurement.

For the carbon NMR, a 30° single pulse sequence is used with proton decoupling only during acquisition to avoid the nuclear Overhauser effects (NOE) and to remain quantitative. The spectral window is adjusted to observe all the resonance lines belonging to the molecules analysed. The accumulation number is adjusted in order to obtain a signal to noise ratio which is sufficient for the quantification of each unit. The recycle delay between each pulse is adapted to obtain a quantitative measurement.

The NMR measurements are performed at 25° C.

### 1-2 Determination of the Tg of the Elastomers

The glass transition temperature (Tg) values described herein are measured in a known manner by DSC (Differential Scanning Calorimetry) according to the standard ASTM D3418 (1999).

### 1-3 Measurement of Tearability

The tearability indices are measured at 100° C. In particular, the force to be exerted in order to obtain breaking (FRD, in MPa (in N/mm²)) is determined and the strain at break (DRD, in %) is measured on a test specimen with dimensions of 10×85×2.5 mm notched at the centre of its length with 3 notches over a depth of 3 mm, in order to bring about breaking of the test specimen stretched at 375 mm/min. Thus, the energy for bringing about breaking (breaking energy) of the test specimen, which is the product of the FRD and DRD, can be determined.

### 1-4 Measurement of the Dynamic Properties

The dynamic properties G*(25%) at 60° C. are measured on a viscosity analyser (Metravib VA4000), according to the standard ASTM D 5992-96. The response of a sample of crosslinked composition (cylindrical test specimen with a thickness of 2 mm and a diameter of 10 mm), subjected to a simple alternating sinusoidal shear stress, at a frequency of 10 Hz, under defined temperature conditions, for example at 60° C., according to the standard ASTM D 1349-99, is recorded. A strain amplitude sweep is performed from 0.1% to 50% (outward cycle) and then from 50% to 1% (return cycle). The results made use of are the complex dynamic shear modulus G* at 25% deformation, at 60° C.

The G* (25%) measurement is a descriptor of the stiffness and therefore an indication of the wear resistance performance of the material. The value in base 100 is calculated according to the operation: (G* (25%) value at 60° C. of the sample/G* (25%) value at 60° C. of the control)*100. In this way, a value lower than the control represents a decrease in the stiffness, whereas a higher value represents a greater stiffness.

### 2 Preparation of the Rubber Compositions:

The rubber compositions, the details of the formulation of which are given in Table 1, were prepared in the following manner:

The elastomer is introduced into an internal mixer (final degree of filling: approximately 70% by volume), the initial vessel temperature of which is approximately 90° C. When the temperature reaches 100° C., the liquid butadiene polymer, the silica, the carbon black and the coupling agent, and also the various other ingredients, with the exception of the sulfur and vulcanization accelerators, are introduced. Thermomechanical working (non-productive phase) is then performed in one step, which lasts in total approximately 3 to 4 min, until a maximum “dropping” temperature of 160° C. is reached. The mixture thus obtained is recovered and cooled, and sulfur and the vulcanization accelerators are then incorporated on an open mill at 25° C., everything being mixed (productive phase) for an appropriate time (for example 5 minutes).

The compositions thus obtained are then calendered either in the form of slabs (thickness of 2 to 3 mm) or thin sheets of rubber for the measurement of their physical or mechanical properties. The crosslinking was then carried out at a temperature of 150° C., under pressure.

### Preparation of the Elastomer

The elastomer (EBR) is prepared according to the following procedure:

The EBR elastomer is prepared in the presence of a catalytic system based on a metallocene [Me₂Si(Flu)₂Nd(μ-BH₄)₂Li (THF)] and a cocatalyst, butyloctylmagnesium, according to the following procedure:

64 l of MCH and a solution of BOMAG (23 mmol) in methylcyclohexane (0.01 mol/1) are introduced into a 90 l stainless steel reactor. The reactor is heated to 80° C. and the monomers are added at a controlled rate so as to keep the composition of the monomer mixture constant in the polymerization medium. The ethylene flow rate is set at 40 g/min and the butadiene is injected independently and the flow rate is controlled by the ethylene flow rate in accordance with the butadiene/ethylene mass ratio equal to 0.55. When the reactor reaches a pressure of 8 bar, preformed catalytic system (6.25 mmol of Nd) at a concentration of 0.007 mol/I prepared according to the protocol described in application WO 2017093654 A1 is introduced into the polymerization medium. The chain termination reaction is performed by a functionalization reaction described according to the functionalization procedure when 5 to 6 kg of polymer are formed: the polymer is recovered after a stripping step. The polymer is then dried on an endless screw machine equipped with a single screw at 150° C.

### Functionalization Procedure:

When the desired monomer conversion has been reached (5 to 6 kg of polymer), the contents of the reactor are degassed and the functionalizing agent, N,N-dimethylaminopropylmethyldimethoxysilane, is introduced into the polymerization medium under an inert atmosphere by excess pressure at a rate of 4 equivalents relative to the number of moles of Nd and of Mg introduced into the reactor. The reaction medium is stirred for 15 minutes at 80° C. The reaction medium is deactivated with methanol. The polymer is recovered after a stripping step. The polymer is then dried on an endless screw machine equipped with a single screw at 150° C. It is then analysed by SEC (THF), ¹H NMR and ²⁹Si NMR.

TABLE 1

| | T1 | C1 | C2 | C3 |
|---|---|---|---|---|
| Elastomer (EBR) (1) | 100 | 100 | 100 | 100 |
| Silica (2) | 38 | 38 | 38 | 38 |
| Carbon black (3) | 2 | 2 | 2 | 2 |
| Coupling agent (4) | 3.1 | 3.1 | 3.1 | 3.1 |
| LBR-307 (5) | | 10 | | |
| X-12-1267B-ES (6) | | | 10 | |
| POLYVEST ST E 100 (7) | | | | 10 |
| DPG (8) | 1.2 | 1.2 | 1.2 | 1.2 |
| Ozone wax (9) | 1 | 1 | 1 | 1 |
| Antioxidant 6PPD (10) | 2 | 2 | 2 | 2 |
| Stearic acid (11) | 2 | 2 | 2 | 2 |
| ZnO (12) | 2.5 | 2.5 | 2.5 | 2.5 |
| Sulfur | 1.3 | 1.3 | 1.3 | 1.3 |
| CBS (13) | 1 | 1 | 1 | 1 |
| G*25% at 60° C. (base 100) | 100 | 84 | 103 | 103 |
| Tearability at 100° C. (base 100) | 100 | 1233 | 337 | 253 |
| Breaking energy (FDR × DRD) | | | | |

(1) Copolymer of ethylene and of 1,3-butadiene containing 75 mol % of ethylene units, 16 mol % of butadiene units in the form of 1,2 and 1,4 units and 9 mol % of 1,2-cyclohexanediyl units which is functionalized at the chain end, function content 35%, functionalizing agent (N,N-dimethyl-3-aminopropyl)methyldimethoxysilane
(2) Zeosil 1165 MP, from Solvay-Rhodia, in the form of micropearls
(3) Carbon black of N234 grade according to the standard ASTM D-1765, from Cabot
(4) Silane Mercapto - Thiocarboxylate Oligomer (NXT-Z45) - CAS 922519-17-3 - from Momentive
(5) LBR-307, from Kuraray, non-functional liquid BR with a Tg of −95° C. and an Mn of 8000 g/mol
(6) X-12-1267B-ES, from Shin-Etsu, liquid BR functionalized along the chain with a Tg of −90° C. and an Mn of 4700 g/mol, of formula
(7) POLYVEST ST E 100 from Evonik, liquid BR with a triethoxysilyl function at each end of the chain, with a Tg of −80° C. and an Mn of 3300 g/mol
(8) Perkacit DPG, diphenylguanidine from Flexsys
(9) Anti-ozone wax, Varazon 4959 from Sasol Wax
(10) N-(1,3-Dimethylbutyl)-N′-phenyl-p-phenylenediamine, Santoflex 6PPD from Flexys
(11) Stearic acid, Pristerene 4931 from Uniqema
(12) Zinc oxide, industrial grade from Umicore
(13) N-Cyclohexyl-2-benzothiazolesulfenamide, Santocure CBS from Flexsys

### 3 Results:

Composition T1 is the control without liquid butadiene polymer in order to evaluate the effect of the nature of the liquid butadiene polymer used in compositions C₁ to C₃ respectively. Compositions C₂ and C₃ are in accordance with the invention.

The results show that the composition in accordance with the invention, with an elastomeric matrix based on a functionalized EBR and a liquid polybutadiene functionalized by at least one alkoxysilyl function, either along the chain or at the ends of the chain, makes it possible to significantly improve the tear resistance while maintaining, or even improving, the stiffness in comparison with a composition not comprising liquid polybutadiene. This effect is observed against all expectations since the joint use of a functionalized EBR and a non-functionalized liquid polybutadiene degrades the stiffness. For a tyre comprising such a composition, the shift in tear resistance and stiffness performance promises an improvement in wear resistance properties with unchanged or even improved road holding.

1.-15. (canceled)

16. A rubber composition based on at least:
an elastomer matrix predominantly comprising a functionalized highly saturated diene elastomer, which highly saturated diene elastomer is a copolymer comprising ethylene units and units of a 1,3-diene in which ethylene units represent at least 50 mol % of monomer units of the copolymer;
a reinforcing filler containing silica;
a coupling agent;
a crosslinking system; and
a liquid butadiene polymer functionalized by at least one alkoxysilyl function, having a number-average molar mass of greater than or equal to 1000 g/mol.

17. The rubber composition according to claim 16, wherein the 1,3-diene is 1,3-butadiene, isoprene, myrcene, β-farnesene, or a mixture of myrcene and β-farnesene.

18. The rubber composition according to claim 16, wherein the functionalized highly saturated diene elastomer bears at least one silanol or alkoxysilyl function.

19. The rubber composition according to claim 16, wherein the functionalized highly saturated diene elastomer bears an amine function and at least one alkoxysilyl or silanol function.

20. The rubber composition according to claim 16, wherein the functionalized highly saturated diene elastomer bears at least one silanol or alkoxysilyl function attached directly to the terminal unit of the copolymer by the silicon atom of the function, which function corresponds to formula (1) 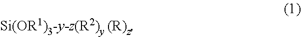
in which:
the symbol R¹, which may be identical or different, represents a hydrogen atom or a C₁-C₁₀ alkyl group,
the symbol R², which may be identical or different, represents a hydrogen atom or a C₁-C₁₀ alkyl group,
the symbol R represents a hydrocarbon chain substituted by an amine function,
y is an integer ranging from 0 to 1, and
z being an integer ranging from 0 to 1.

21. The rubber composition according to claim 16, wherein a content of functionalized highly saturated diene elastomer varies within a range extending from 60 to 100 phr.

22. The rubber composition according to claim 16, wherein the at least one alkoxysilyl function of the liquid butadiene polymer is a trialkoxysilyl function, corresponding to a formula —Si(OR)₃, in which R denotes a C₁-C₁₀ alkyl.

23. The rubber composition according to claim 16, wherein the functionalized liquid butadiene polymer bears at least one pendant alkoxysilyl function along the chain.

24. The rubber composition according to claim 16, wherein the functionalized liquid butadiene polymer bears an alkoxysilyl function at at least one end of the main chain.

25. The rubber composition according to claim 16, wherein a content of functionalized liquid butadiene polymer is within a range extending from 0.5 to 25 phr.

26. The rubber composition according to claim 16, wherein the reinforcing filler comprises silica as a predominant reinforcing filler.

27. The rubber composition according to claim 16, wherein a content of reinforcing filler is within a range extending from 10 to 100 phr.

28. The rubber composition according to claim 16, wherein a content of silica is within a range extending from 15 to 70 phr.

29. A finished or semi-finished product comprising the rubber composition according to claim 16.

30. A tire comprising the rubber composition according to claim 16.
